(19) United States
(12) Patent Application Publication
(10) Pub. No.: US 2025/0225796 A1
(43) Pub. Date: Jul. 10, 2025

(54) VEHICULAR MANAGEMENT SYSTEM WITH TEXT TRANSLATION LAYER

(71) Applicant: Affectiva, Inc., Boston, MA (US)

(72) Inventors: Panu James Turcot, Revelstoke (CA); Rana el Kaliouby, Milton, MA (US); Ajjen Das Joshi, Arlington, MA (US); Gabriele Zijderveld, Somerville, MA (US)

(73) Assignee: Affectiva, Inc., Boston, MA (US)

(21) Appl. No.: 19/008,742

(22) Filed: Jan. 3, 2025

Related U.S. Application Data
(60) Provisional application No. 63/617,798, filed on Jan. 5, 2024.

(51) Int. Cl. G06V 20/59; B60W 60/00; G06F 40/20

(52) U.S. Cl. CPC G06V 20/59; B60W 60/001; G06F 40/20

(57) ABSTRACT

Techniques for managing vehicles are disclosed. One or more images are obtained of a vehicle occupant using one or more imaging devices within the vehicle. The one or more images are augmented with in-cabin sensor data. The one or more images include facial data of the vehicle occupant. A computing device is used to analyze the one or more images to determine an in-cabin state. The in-cabin state is processed using a text translation layer. The text translation layer is configured using configurability parameters. The processing outputs one or more text sentences describing the in-cabin state. A generative artificial intelligence (AI) facility is seeded using the one or more sentences. The vehicle is managed based on a textual response from the generative AI facility. The managing the vehicle includes indexing in-cabin state information. The managing the vehicle further includes providing vehicle manipulation instructions.

### RELATED APPLICATIONS

This application claims the benefit of U.S. provisional patent application “Vehicular Management System With Text Translation Layer” Ser. No. 63/617,798, filed Jan. 5, 2024.

The foregoing application is hereby incorporated by reference in its entirety.

### FIELD OF ART

This application relates generally to vehicular management and more particularly to a vehicular management system with text translation layer.

### BACKGROUND

Effective human communication is based on patterns inherent in speech, such as tone, volume, and cadence. Facial expressions that accompany the patterns of speech further communicate critical information. These speech patterns and facial expressions transpire while the interpersonal communication is taking place. The facial expressions occur at times consciously and at other times subconsciously, based on a particular facial expression and a context of the conversation. The information conveyed by the facial expressions of both the speaker and the listener provides basic yet essential indications about the participants, such as mental states, cognitive states, moods, emotions, etc. The facial expressions of the speaker and the listener are formed by physical movements or positions of various facial muscles. These facial expressions convey key information as to the emotions of the speaker and of the listener. The emotions that are communicated between speaker and listener can range from sad to happy, angry to calm, and from bored to engaged, among many others. The emotions form the basis for the facial expressions of anger, fear, disgust, or surprise, among many others.

The facial expressions of an individual can be captured and analyzed for a wide range of purposes. The purposes often include implementation of commonly used applications such as identification of a person, facial recognition, and determination of emotions and mental states associated with the person. The mental states that are determined based on the capture and analysis of facial expressions include frustration, ennui, confusion, cognitive overload, skepticism, delight, satisfaction, calmness, stress, and many others. Similarly, the sound of the human voice can be captured and analyzed to detect and identify vocal characteristics or cues that support human communication. The human voice further conveys critical information relating to mental states, moods, emotions, etc. In a manner analogous to facial expression capture and analysis, mental state determination can be based on capture and analysis of voice characteristics, including timbre, prosody, vocal register, vocal resonance, pitch, loudness, speech rate, and language content. Voice cues are often referred to as paralanguage cues. Non-verbal communication also occurs between and among people. Nonverbal communication supplements and enhances verbal communication, and can be categorized as visual cues, distance cues, voice cues, and touch cues. Visual cues often include body language and facial expressions. An angry face and a smiling face convey very different messages. Physical distance cues are also informative. Towering over another person, or being “in their face,” threatens and intimidates the person who is on the receiving end. On the other hand, sitting with the person conveys reassurance. Other senses further contribute to human communication. A reassuring touch or various haptic cues are also used for effective, nonverbal communication.

### SUMMARY

Effective management of a vehicle such as an automobile is critical to the safety and wellbeing of the occupants of the vehicle. The vehicle management further ensures the safety of occupants of adjacent vehicles, pedestrians, cyclists, and others who may be adjacent to the vehicle or encountered along a travel path of the vehicle. The management of the vehicle includes delivering messages, alerts, and warnings to the operator or passenger of the vehicle; enabling or denying access to a vehicle; transferring control of the vehicle from the operator to a semiautonomous or autonomous operation mode; and so on. The wide range of management options depends in part on the type of vehicle being managed, whether a manually operated, semiautonomous, or autonomous vehicle. The management options are further based on determined in-cabin states. The in-cabin states include occupant states and cabin states. The occupant states are determined by analyzing images obtained from vehicle occupants using imaging devices. The occupant states include cognitive states, mental states, and moods. The cabin states are determined by analyzing images and in-cabin sensor data. The cabin states include lighting, temperature, audio, etc. The in-cabin states are processed to generate text sentences that describe the occupant states and cabin states. The text sentences are used to seed a generative artificial intelligence (AI) facility, which generates a text response that is used to manage the vehicle. The text response from the AI facility can be displayed or played to the vehicle driver and/or occupant, can transfer vehicle control, etc. The presentation of the management text responses can range from friendly reminders to safety recommendations to urgent warnings. The Al generated textual responses thereby manage the vehicle operated by a driver who is or is predicted to become unsafe, distracted, or impaired.

Disclosed techniques include a vehicular management system with a text translation layer. One or more images of a vehicle occupant are obtained using one or more imaging devices within the vehicle. The one or more images include facial data of the vehicle occupant. The one or more images are augmented with in-cabin sensor data. The in-cabin sensor data can include cabin temperature and climate, seat adjustments, audio soundtracks, presence of conversation, and so on. A computing device is used to analyze the one or more images to determine an in-cabin state. The in-cabin state includes a driver state and one or more passenger states. The driver state and the one or more passenger states can include emotional state, gaze direction, and/or verbal participation. The in-cabin state is processed using a text translation layer. The in-cabin state comprises output from a software development kit that includes the text translation layer. The text translation layer is configured using configurability parameters. The configurability parameters can include in-cabin state signal selection, a verbosity setting for text sentences, and consolidating text sentences. The processing outputs one or more text sentences describing the in-cabin state. A generative artificial intelligence (AI) facility is seeded using the one or more sentences. The vehicle is managed based on a textual response from the generative AI facility. The managing the vehicle includes indexing in-cabin state information. The managing the vehicle further includes providing vehicle manipulation instructions.

A computer-implemented method for vehicular management is disclosed comprising: obtaining one or more images of a vehicle occupant, using one or more imaging devices within the vehicle, wherein the one or more images include facial data of the vehicle occupant; analyzing, using a computing device, the one or more images to determine an in-cabin state; processing the in-cabin state using a text translation layer, wherein the processing outputs one or more text sentences describing the in-cabin state; seeding a generative artificial intelligence (AI) facility, using the one or more sentences; and managing the vehicle, based on a textual response from the generative AI facility. In embodiments, the text translation layer enables integration with diverse generative AI facilities. Some embodiments comprise configuring the text translation layer using configurability parameters. In embodiments, the configurability parameters include in-cabin state signal selection.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a vehicle management system with a text translation layer.

FIG. 2 is a flow diagram for text translation layer usage.

FIG. 3 is a block diagram for a text translation layer.

FIG. 4 is a system diagram for an interior of a vehicle.

FIG. 5 is an example showing a convolutional neural network (CNN).

FIG. 6 illustrates a bottleneck layer within a deep learning environment.

FIG. 7 shows data collection including devices and locations.

FIG. 8 is a system for a vehicle management system with a text translation layer.

### DETAILED DESCRIPTION

Vehicles of many types are used for various travel objectives including commuting to work or school, business trips, recreational travel, and so on. The use of vehicles is so prevalent that individuals can spend hundreds of hours or more per year getting to, waiting for, and traveling in vehicles. Different types of vehicles can be used, depending on where travelers live, climatic conditions, distances to travel, personal safety, and so on. The vehicles typically include common vehicles such as buses, trains, airplanes, automobiles, ferries, and so on. Other vehicles used for travel include motorcycles, mopeds, bicycles, and scooters. For those travelers who do not own a vehicle, who are traveling away from home, or prefer to let someone else do the driving, ride-sharing services such as Uber™, Lyft™, and others are popular transportation alternatives. Annual travel time rapidly accumulates when travelers are commuting to and from the office, taking the kids to soccer practice and piano lessons, taking the pets to the veterinary, shopping, traveling, and participating in the many other common activities that require transportation. Travel can also be a loathsome activity. For many travelers, travel at its best is time consuming, and at worst is boring, frustrating, irritating, stressful, and potentially frightening. Rush hour traffic, accidents, incompetent or dangerous vehicle operators, and badly maintained roads further complicate vehicular transportation. Other transportation difficulties include operating an unfamiliar vehicle, driving in an unfamiliar city or area, navigating a bewildering public transportation network, or even having to remember to drive on the opposite side of the road. These transportation challenges can result in catastrophic consequences and outcomes. Irritated vehicle operators can experience road rage and other antisocial behaviors, while bored, sleepy, tired, impaired, distracted, or inattentive drivers can cause vehicular accidents and injury to themselves, pedestrians, bicyclists, animals, and property.

Vehicular management can be achieved by analyzing images and sensor data obtained of a vehicle occupant. The images can include facial data. More than one occupant can be present in the vehicle, so additional images and sensor data can be obtained. The analyzing of the images and sensor data can determine one or more in-cabin states. The in-cabin states can include one or more states associated with an occupant such as the operator or driver of the vehicle. The in-cabin states can include mental states, cognitive states, moods, and so on. Analysis of the various in-cabin states that can be performed for a vehicle occupant can include cognitive analysis that can identify a range of cognitive states of the individual. The cognitive states of the individual can be used to understand other states of the individual such as emotional states, mental states, moods, and so on. By understanding the cognitive states of the individual, various vehicle management decisions can be determined by a generative artificial intelligence (AI) facility. The AI facility can generate textual responses that can be used to manage the vehicle. The textual responses can be provided to the vehicle occupant on a display, spoken to the occupant, and so on. The textual responses can also be used to make adjustments to the vehicle. The adjustments to the vehicle can include modifying light levels, adjusting climate settings, etc. The textual response can further be used to transfer control (i.e., directed control transfer) of the vehicle from the driver to semiautonomous mode or autonomous mode. The benefits of directed control transfer for an autonomous vehicle include enhancing the transportation experience for the individual and improving road safety. The enhanced transportation experience for the individual includes autonomous operation, security, or comfort. The road safety improvements derive from aiding the individual who is navigating in foreign surroundings or operating an unfamiliar vehicle, and from preventing a sleepy, impaired, or inattentive individual from operating the vehicle.

A generative artificial intelligence facility can be trained to accomplish vehicular management. Training of the AI facility is based on techniques such as applying “known good” data to a neural network in order to adjust one or more weights or biases, to add or remove layers, etc. within the neural network. The adjusting weights can be performed to enable applications such as machine vision, machine hearing, and so on. The adjusting weights can be performed to determine facial elements, facial expressions, human perception states, cognitive states, emotional states, moods, etc. In a usage example, the facial elements comprise human drowsiness features. Facial elements can be associated with facial expressions, where the facial expressions can be associated with one or more cognitive states. The various states can be associated with an individual as she or he interacts with an electronic device or a computing device, consumes media, travels in or on a vehicle, and so on. However, a lack of diversified training datasets causes poor evaluation performance, especially in under-represented classes. Further, learning models might not reflect “in-the-wild,” real-life conditions. That is, the quality of machine learning results is limited by the training datasets available, hence the need for high quality synthetic training data. The synthetic data for neural network training can use synthetic images for machine learning. The machine learning is based on obtaining facial images for a neural network training dataset. A training dataset can include facial lighting data, facial expression data, facial attribute data, image data, audio data, physiological data, and so on. The images can include video images, still images, intermittently obtained images, and so on. The images can include visible light images, near-infrared light images, etc. An encoder-decoder pair can decompose an image attribute subspace and can produce an image transformation mask. Multiple image transformation masks can be generated, where the transformation masks can be associated with facial lighting, lighting source direction, facial expression, etc.

One or more images of a vehicle occupant are obtained for processing on a generative AI facility. The one or more images can include facial data, facial lighting data, lighting direction data, facial expression data, and so on. In-cabin sensor data can also be obtained from the vehicle. The in-cabin sensor data can include temperature, audio content including speech or a soundtrack, interior climate data, exterior climate data, and so on. The in-cabin sensor data can further include vehicle settings such as seating position, mirror positions, soundtrack choices, etc. Various components such as imaging components, microphones, sensors, and so on can be used for collecting the facial image data and other data. The imaging components can include cameras, where the cameras can include a video camera, a still camera, a camera array, a plenoptic camera, a web-enabled camera, a visible light camera, a near-infrared (NIR) camera, an infrared (IR) heat camera, and so on. The images and/or other data are processed using a text translation layer. The images and/or other data can be further used for training purposes, such as training a generative Al facility. The images and/or data are analyzed to determine one or more in-cabin states. The one or more in-cabin states can include operator states and vehicle cabin states. The in-cabin states are processed using a text translation layer. The text translation layer outputs one or more text sentences describing the in-cabin state or states. The output text sentences are used to seed a generative AI facility. More than one AI facility can be seeded. The seeded AI facility generates a textual response. The textual response can include information, directions, and so on to the vehicle occupant. The textual responses can further include vehicle manipulation instructions. The vehicle manipulation instructions can control various aspects of the vehicle such as climate control, soundtrack selection, recommended travel route, and so on. The vehicle manipulation instructions can further transfer control of the vehicle from the driver of the vehicle to semiautonomous or autonomous operation. The transfer of vehicle control can be indicated by driver inattention, distraction, impairment, etc.

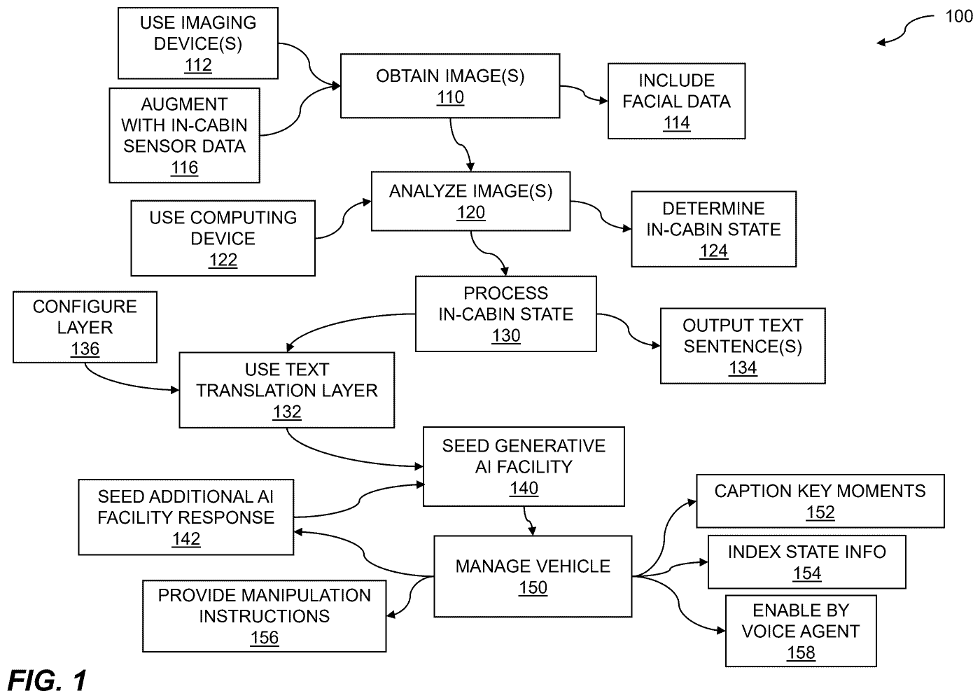

FIG. 1 is a flow diagram for a vehicle management system with a text translation layer. The flow 100 is based on a computer-implemented method for vehicular management. The flow 100 includes obtaining one or more images 110 of a vehicle occupant. The vehicle occupant can include an operator or driver of the vehicle, a passenger within the vehicle, and so on. In the flow 100, the obtaining is accomplished using one or more imaging devices 112 within the vehicle. The imaging devices can include a video camera, a web camera, a still camera, an infrared camera, etc. In the flow 100, the one or more images include facial data 114 of the vehicle occupant. The facial data can include full facial data, profile data, partially obscured data, etc. The data can include red-green-blue (RGB) data. The data can include video frames. In addition to image data, further data of a vehicle occupant can be obtained. The further data that can be obtained can include sensor data. The sensors from which the further data can be obtained can include one or more of audio sensors, temperature sensors, activity sensors, and so on. The flow 100 further includes augmenting 116 the one or more images with in-cabin sensor data. The in-cabin sensor data can be correlated with the video data. In a usage example, audio data can be correlated with the image data to confirm that a vehicle driver is talking, producing nonspeech sounds, snoring, etc.

The flow 100 includes analyzing 120 the one or more images. The analyzing the one or more images can include one or more image analysis techniques. The image analysis techniques can include identifying and locating facial regions, facial landmarks, facial features, and so on. The facial regions can include eyes, nose, mouth, cars, forehead, chin, and so on. Facial landmarks can include corners of eyes, corners of eyebrows, tip of nose, corners of mouth, cars, etc. The facial features can include eyewear such as glasses or an eyepatch, presence or absence of facial hair, presence or absence of a mask or facial covering, hairline, etc. In the flow 100, the analyzing can be accomplished using a computing device 122. The computing device can include a computer, a server, a processor, a multiprocessor, a processor core, and so on. The computing device can include a desktop computer; a laptop computer; a handheld device such as a tablet, PDA, or smartphone; and the like. In the flow 100, the analyzing using the computing device determines an in-cabin state 124. The in-cabin state can include a state associated with an occupant of the vehicle. The occupant state can include a cognitive state, a mental state, a mood, an emotion, and so on. The in-cabin state can include a cabin state, vehicle state, etc. The cabin state can include driver present, passenger present, driver seatbelt in use, passenger seatbelt in use, and the like. The cabin states can include true/false states, one/zero states, and the like.

The flow 100 includes processing the in-cabin state 130. The processing can be performed using a computing device, a processor, a multiprocessor, a server, and so on. The processing the in-cabin state can output text that describes the in-cabin state. In the flow 100, the processing is accomplished using a text translation layer 132. The text translation layer can process or “convert” the in-cabin state. In the flow 100, the processing outputs one or more text sentences 134 describing the in-cabin state. In a usage example, the driver of a vehicle is not wearing their seatbelt. As a result, an in-cabin state, “driver_seat_belt_status,” can equal “false,” zero, etc. The text translation layer can process the seatbelt status state to output a text sentence such as, “Driver seatbelt is not engaged,” or “Driver seatbelt is not clicked.” The example shows that more than one sentence can be output, and that different expressions, words, phrases, vocabularies, etc., can be used to describe the same in-cabin state.

The text translation layer can be configured. The flow 100 further includes configuring the text translation layer 136 using configurability parameters. The configuring can include selecting a tone, vocabulary, sentence structure, and so on. The tone can include a polite suggestion, a command, etc. One or more configurability parameters can be used. In embodiments, the configurability parameters include in-cabin state signal selection. The in-cabin signal selection can select from among multiple imaging devices, multiple sensors, and the like. The selection can be used to isolate image data and sensor data associated with the driver of the vehicle, a passenger within the vehicle, and so on. The selection can be used to prioritize signals. In a usage example, image data associated with the driver can be prioritized over image data associated with a passenger. The priority can be set to detect a potential operating hazard if the driver is drowsy, while detection of a drowsy passenger can be less critical. In other embodiments, the configurability parameters include a verbosity setting for the one or more text sentences. The sentences that are output can be controlled by sentence length, sentence structure, vocabulary, and the like. The verbosity setting can be used to enable improved results from a generative artificial intelligence (AI) facility (discussed below). In embodiments, the configurability parameters enable consolidating the one or more text sentences prior to the seeding. Sentence consolidation can be accomplished by appending one sentence to another sentence, by coupling the sentences using conjunctions such as “and” or “or”, etc. The sentence consolidation can generate sentences that can be processed by various generative AI facilities. In embodiments, the text translation layer enables integration with diverse generative AI facilities. The diverse generative AI facilities can include ChatGPT™, Scribe™, Jasper™, Generative Design™, Dall-E2, Notion™, Wordtune™, Github Copilot™, Speechify™, VEED™, and so on.

The flow 100 includes seeding 140 a generative artificial intelligence (AI) facility, using the one or more sentences. Seeding a generative AI facility can include providing “starter sentences” or “seeds” from which the generative AI facility can generate textual responses. Recall that the one or more sentences output by the text translation layer include text associated with an in-cabin state. The generative AI facility can be used to generate a textual response that can be used to manage the vehicle. Continuing the usage example where the driver seatbelt state indicates that the seatbelt is unused, the generative AI facility can generate a textual response that includes a proposed resolution to or adjustment of the state. The proposed solution can include, “Driver, please click your seatbelt for safety.” In embodiments, the text translation layer can provide a prompt to the generative AI facility to enable the seeding. The prompt can include controls, parameters, etc. In embodiments, the prompt can include metadata instructions to the generative AI facility. The metadata instructions can include language, sentence structure, vocabulary, and so on. In embodiments, the metadata instructions can include voice characteristics. The voice characteristics can include tone, prosody, speech rate, etc. The voice characteristics can further include female, male, polite, command, urgent, and the like. In a usage example, a polite suggestion associated with an unused seatbelt state can include, “Please click your seatbelt for safety.” Alternatively, a command can include, “Click seatbelt now to enable vehicle operation.”

The flow 100 includes managing 150 the vehicle, based on a textual response from the generative AI facility. The managing the vehicle can include providing suggestions, recommendations, and directions to the driver of the vehicle, a passenger within the vehicle, or both the driver and a passenger. The managing the vehicle can provide manipulation instructions 156. The managing the vehicle can include rendering a message on a display within the vehicle, where the display can include a display associated with the vehicle, a display associated with an electronic device affiliated with the driver or a passenger, and so on. In embodiments, the vehicle manipulation instructions can be delivered audibly within the vehicle. The audible instructions can be intended for the driver or operator of the vehicle, for a front seat passenger if present within the vehicle, for a back seat passenger, and so on. In embodiments, the vehicle manipulation instructions that are delivered audibly can be directed to a driver of the vehicle. In other embodiments, the vehicle manipulation instructions that are delivered audibly can be directed to a passenger of the vehicle. The managing can include providing audio to occupants of the vehicle through a sound system within the vehicle, a sound system for management purposes, etc. In embodiments, the managing the vehicle can be enabled by a voice agent 158 vocalizing the textual response from the generative AI facility. The managing can include alerts about traffic conditions, weather conditions, road construction, and accident reports. The managing can include suggesting a travel route. The managing can include suggesting a soundtrack for a travel route.

In embodiments, the managing the vehicle can include providing vehicle manipulation instructions. The vehicle manipulation instructions can include operating one or more systems within the vehicle. In embodiments, the vehicle manipulation instructions can be delivered electronically to an autonomous or semi-autonomous vehicle control processor. The systems that can be controlled autonomously or semi-autonomously can include power train, steering, braking, and the like. The managing can include transferring control of the vehicle from the driver of the vehicle to semiautonomous or autonomous mode. In embodiments, vehicle manipulation instructions can modify vehicle control. The modifying vehicle control can include transferring vehicle control from the driver to the semiautonomous or autonomous vehicle, transferring vehicle control from semiautonomous or autonomous mode to the driver, etc. In other embodiments, the vehicle manipulation instructions can modify vehicle in-cabin climate settings. The modifying climate settings can include increasing or decreasing climate settings, suggesting that a vehicle occupant crack a window to provide fresh air, etc. In further embodiments, the vehicle manipulation instructions can enable fleet monitoring. The fleet monitoring can include enabling or denying vehicle access, tracking vehicle operation such as speed, tracking vehicle location, and the like. In other embodiments, the vehicle manipulation instructions can trigger a continued dialogue between the text translation layer and the generative AI facility. The continued dialogue is a technique that can be used to track and respond to changing conditions associated with the vehicle. In embodiments, the continued dialogue can enable increasing or decreasing severity of additional vehicle management actions. An increasing severity can include a driver getting drowsy and then falling asleep. A decreasing severity can include the driver pulling over and a passenger taking over driving.

Recall that vehicle management is based on obtaining image data such as facial data, sensor data such as in-cabin conditions, and so on. In the flow 100, the managing the vehicle can include captioning key moments 152 within the vehicle. The key moments can include moments associated with a vehicle occupant. The key moments can include notable in-cabin states. In a usage example, a notable in-cabin state can include a facial expression such as an angry or bored expression, a yawn, snoring, etc. The captioning can include a marker, a flag, a label, text, etc. In embodiments, the key moments can include in-cabin state changes. The in-cabin changes can include changes in perceived cognitive states, changes in facial expressions, changes in attention or focus, and so on. In the flow 100, the managing the vehicle comprises indexing 154 in-cabin state information. The indexing can be accomplished using a “bookmark,” a “pin,” etc. The indexing can include a time marker, a frame number, or some other marking of a location within images, sensor data, and so on. In embodiments, the indexing can enable data mining of an in-cabin state timeline. The data mining can identify patterns within data such as facial image data, sensor data, and the like. In a usage example, the driver of the vehicle can be determined to start yawning at a particular point along a travel route. In other embodiments, the indexing can enable synchronization of in-cabin state changes and one or more responses from the generative AI facility. The synchronization can be used to measure the effectiveness of textual responses from the generative AI facility. The flow 100 further includes seeding an additional generative AI facility response 142, based on a change of the in-cabin state subsequent to the managing. The additional generative AI response can be compared to the generative AI response. The comparison can include determining which response is preferred over the other, whether the responses substantially match, and so on.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

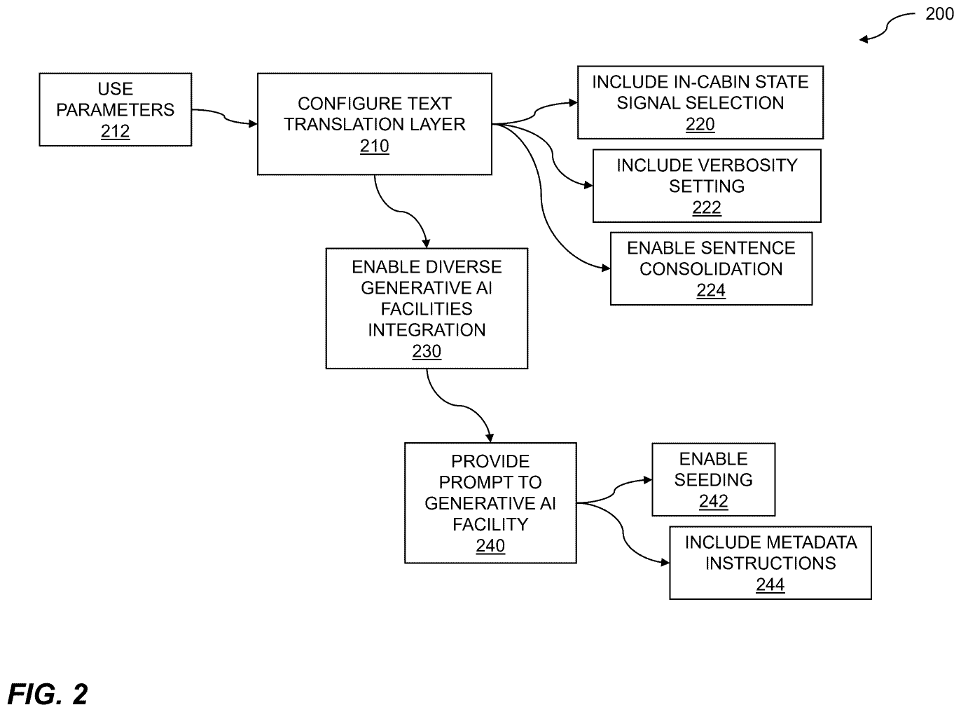

FIG. 2 is a flow diagram for text translation layer usage. The text translation layer is used to process the in-cabin state that was determined by analyzing one or more images. The images are captured of an individual within a vehicle. The result of processing by the text translation layer is to output one or more text sentences that describe the in-cabin state. The text sentences are used to seed a generative AI facility. The text generation layer can further engage in a continued dialogue with the generative AI facility. The continued dialogue enables increasing or decreasing severity of vehicle management actions. Using the text translation layer enables a vehicular management system. One or more images of a vehicle occupant are obtained, using one or more imaging devices within the vehicle, wherein the one or more images include facial data of the vehicle occupant. A computing device is used to analyze the one or more images to determine an in-cabin state. The in-cabin state is processed using a text translation layer, wherein the processing outputs one or more text sentences describing the in-cabin state. A generative artificial intelligence (AI) facility is seeded, using the one or more sentences. The vehicle is managed, based on a textual response from the generative AI facility.

The flow 200, or portions thereof, can be implemented using one or more computers, processors, personal electronic devices, and so on. The flow 200 can be implemented using one or more networks such as neural networks. The flow 200 describes using a text translation layer to generate text sentences that are used to seed a generative AI facility. The generative Al facility returns textual responses that are used to manage a vehicle. Further, the text translation layer enables interaction with diverse generative AI facilities. The flow 200 includes configuring the text translation layer 210. The configuring the text translation layer can be used to specify, control etc., various capabilities of the layer. The capabilities can include language, sentence structure, vocabulary, sentence complexity, and so on. In the flow 200, the configuring is accomplished using configurability parameters 212. The configuring can select input sources such as number and types of cameras, in-cabin sensors, and the like. In the flow 200, the configurability parameters include in-cabin state signal selection 220. The in-cabin state signal selection can include selecting an image capture device with the best, least obstructed view of a vehicle occupant. The in-cabin state selection can include selecting multiple video capture devices, types of capture devices, etc. The in-state cabin selection can further include selecting sensors within the vehicle. The sensors can include audio, temperature, climate, activity, etc. sensors. In the flow 200, the configurability parameters include a verbosity setting 222 for the one or more text sentences. The verbosity setting can be used to select a minimum or maximum number of words in a sentence produced by the processing. The verbosity setting can further select a vocabulary such as a simple or direct vocabulary, a technical vocabulary, etc. In the flow 200, the configurability parameters enable consolidating 224 the one or more text sentences prior to the seeding. The consolidation can be accomplished by concatenating sentences into a list, combining using an “and” or an “or” sentence structure, etc. The combining can combine multiple in-cabin states into one or two sentences.

In the flow 200, the text translation layer enables integration 230 with diverse generative AI facilities. The text translation layer can integrate with a single generative AI facility, two or more generative AI facilities, and so on, for management of a single vehicle. The two or more generative AI facilities can be integrated in order for the facilities to “compete” for vehicle management responses. In a usage example, two or more generative AI facilities are seeded with two sentences output by processing the in-cabin state. The textual responses of the two or more AI facilities can be compared and contrasted for a consistent or majority response (e.g., a vote), for one response being preferred to or better than other responses, etc. A wide variety of generative AI facilities can be used, such as ChatGPT™, Scribe™, Jasper™, Generative Design™, Dall-E2, Notion™, Wordtune™, Github Copilot™, Speechify™, VEED™, and so on. In the flow 200, the text translation layer provides a prompt 240 to the generative AI facility. The prompt can include a signal, a command, a direction, etc. In the flow 200, the prompt is provided to enable the seeding 242. The prompt can include signals such as data ready, instructions such as load data or execute, etc. In the flow 200, the prompt includes metadata instructions 244 to the generative AI facility. The metadata instructions can specify one or more characteristics or parameters associated with the textual response from the generative AI facility. In embodiments, the metadata instructions can include voice characteristics. The voice characteristics can include a female or male voice, a child's voice, a cartoon voice, and so on. The voice characteristics can include a friendly or calm tone, an instructive tone, an urgent tone, and so on. In a usage example, the voice characteristics can include a female voice using a calm tone to remind the driver of the vehicle to use their seatbelt by buckling up. In another usage example, an urgent tone can be used to warn a driver of hazardous road conditions or dangerous vehicle operation.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

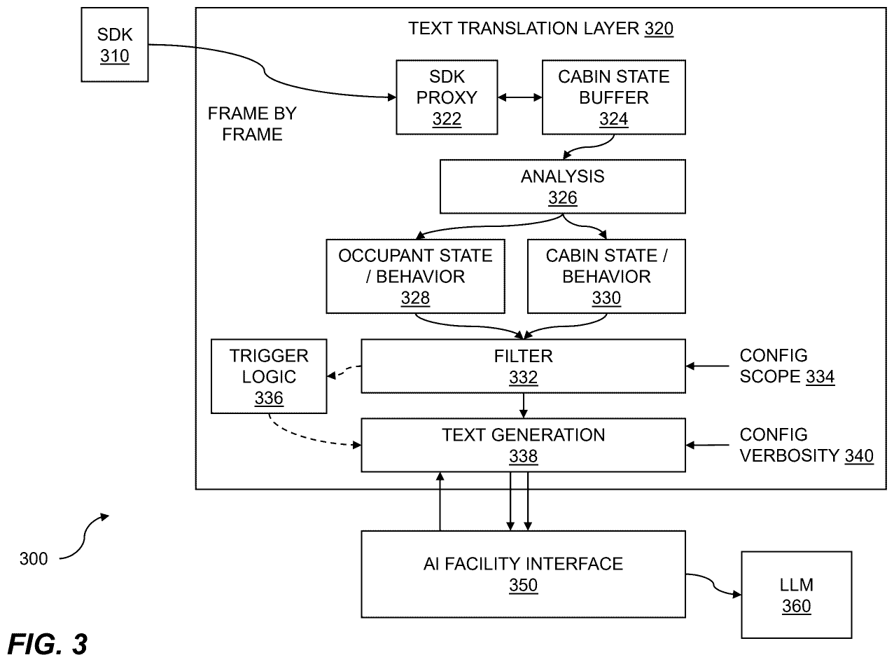

FIG. 3 is a block diagram for a text translation layer. A text translation layer can be used to translate one or more in-cabin states that can be determined by analysis of images of a vehicle occupant into a useful, recognizable set of inputs to/from an AI facility. The one or more in-cabin states can include binary states or conditions such as driver_seat_belt_status being true when the seatbelt is being used or false when the seatbelt is not in use. The text translation layer converts one or more in-cabin states into one or more sentences. Thus, an in-cabin state such as “driver_seat_belt_status=false” can be converted into text such as, “The driver is not wearing their seatbelt.” The text translation layer can generate one or more sentences for each in-cabin state, can combine in-cabin states into a single sentence, and so on. The text translation layer enables a vehicle management system. One or more images are obtained of a vehicle occupant, using one or more imaging devices within the vehicle, wherein the one or more images include facial data of the vehicle occupant. A computing device is used to analyze the one or more images to determine an in-cabin state. The in-cabin state is processed using a text translation layer, wherein the processing outputs one or more text sentences describing the in-cabin state. A generative artificial intelligence (AI) facility is seeded, using the one or more sentences. The vehicle is managed, based on a textual response from the generative AI facility.

The block diagram 300 can include a software development kit (SDK) 310. The SDK can enable programmers, coders, developers, and others to access a framework, a platform, and so on. The SDK can include one or more libraries; tools such as debugging tools; testing frameworks; integrated development environments (IDEs) that enable writing, debugging, and testing code; and so on. The SDK can further include an application programming interface (API). The API can enable interaction with platform or language services and features. The SDI can include sample code, plug-ins, etc. The API can greatly simplify and speed development of applications and systems that use text generation. The SDK can interface with a text translation layer 320. The text translation layer can be implemented in a common programming language such as Python™, Java™, C++ TM, JavaScript™, Julia™, LISP™, Prolog™, and so on. The SDK can provide state input information such as video data, facial data, torso data, vehicle data, sensor data, and the like. The data can be provided on a frame-by-frame video basis and/or a word-by-word audio basis. The text translation layer (TTL) can translate one or more in-cabin states, which are determined by analysis of images and/or audio of a vehicle occupant, into a useful, recognizable set of inputs to/from an AI facility. The TTL enables real time, in-cabin voice and/or textual responses to a vehicle occupant (user) from a remote large language model (LLM) artificial intelligence (AI) instantiation, thereby augmenting the in-cabin “relationship” with the occupant(s). All or part of text translation layer 320 can be included on a semiconductor chip and implemented in special purpose logic, programmable logic, and so on.

The block diagram 300 can include an SDK proxy 322. The SDK proxy can handle requests to a service accessed via the SDK. The SDK proxy can reduce the numbers of service access requests. Reducing the numbers of service requests can improve service processing speed, efficiency, etc. The block diagram 300 can include a cabin state buffer 324. The cabin state buffer can include a cache, a memory element, and so on. The cabin state buffer can hold cabin states in the order they were received, in an order orchestrated by the SDK proxy, etc. The block diagram 300 can include an analysis element 326. The analysis element can include a computing device, a processor, and so on. The analysis element can analyze one or more images obtained by one or more imaging devices. The analyzing can determine an in-cabin state. The in-cabin state can include an occupant state/behavior 328 and a cabin state/behavior 330. The in-cabin occupant state/behavior can include a state associated with an individual, where the individual can include a driver or operator of the vehicle, a passenger, and so on. The in-cabin state can include driver_seat_occupied, passenger_seat_occupied, driver_seat_belt status, passenger_seat_belt_status, etc. The in-cabin state can be described as true or false, one or zero, and the like. The cabin state/behavior can be associated with the vehicle. The in-cabin state can include audio_present, conversation_present, cabin_climate, lighting_level, and so on.

The block diagram 300 can include a filter 332. The filter can be used to select one or more in-cabin states to be forwarded for text generation. The filter can be configured based on providing one or more configuration parameters. The configuration parameters can include a configuration scope 334. The configuration scope can include using the filter to select in-cabin characteristics associated with the vehicle driver, with the vehicle passenger, with all vehicle occupants, and the like. In embodiments, the configurability parameters can include in-cabin state signal selection. The filter can be used to detect a threshold. A threshold can include an amount of activity, a minimum amount of activity, a detected facial expression, etc. A threshold can be used to engage trigger logic 336. The trigger logic can activate text translation for vehicle management. In a usage example, an in-cabin state associated with an occupant can indicate that the driver of the vehicle is drowsy. The trigger logic can activate text generation to generate text associated with the in-cabin state.

The block diagram 300 can include text generation 338. Text generation can be used to generate text that represents an in-cabin state. In a usage example, an in-cabin state can include “passenger_seat_occupied=true.” The text generation can generate one or more sentences that can represent the true state. The sentence generated by text generation can include, “A passenger is present in the passenger seat.” The text generation can be configured using one or more parameters. In embodiments, the configurability parameters can include a verbosity setting 340 for the one or more text sentences. The verbosity setting can configure a number of words in a sentence, vocabulary, sentence complexity, and the like. In other embodiments, the configurability parameters can enable consolidating the one or more text sentences prior to seeding an artificial intelligence (AI) facility. The block diagram 300 can include an Al facility interface 350. The AI facility interface can enable communication between the compiler block 320 and one or more AI facilities. In embodiments, the AI facilities can include ChatGPT™, Scribe™, Jasper™, Generative Design™, Dall-E2, Notion™, Wordtune™, Github Copilot™, Speechify™, VEED™, and so on. The seeding the AI facility can include providing the one or more text sentences generated by the text generator, one or more configuration parameters, one or more directives to the Al facility, etc. Further embodiments can include an additional generative AI facility response, based on a change of the in-cabin state subsequent to the managing. The additional generative AI facility response can be used to augment the first AI facility response, to replace the first response, and the like. The AI facility interface can further interface with a large language model (LLM) 360. The LLM can include a vocabulary, sentences, rules for constructing sentences, and so on. The LLM can be used to interpret the one or more sentences generated by the text generator. The interpretation can include determining one or more recommended actions based on the generated text sentences. The one or more recommended actions can include vehicle management actions.

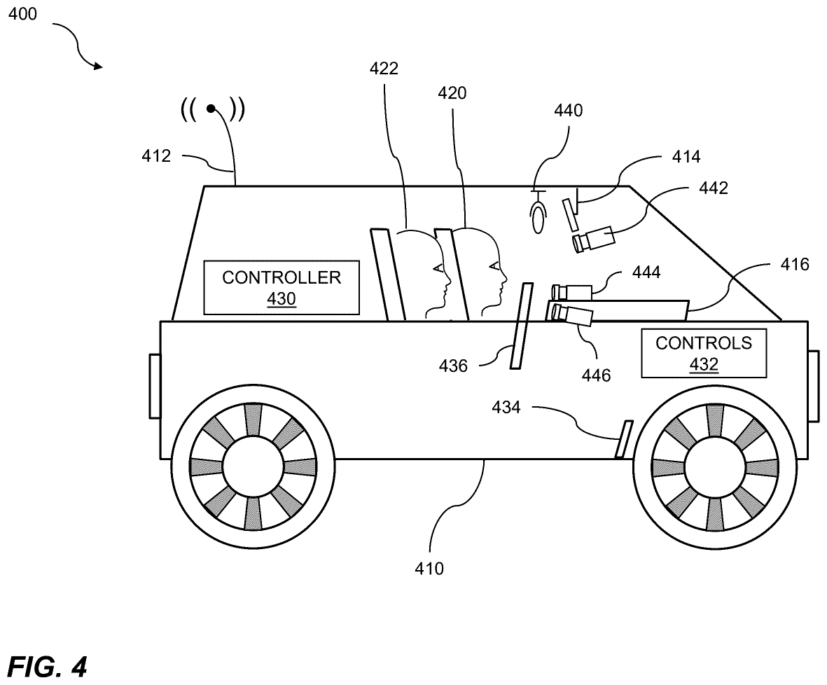

FIG. 4 is a system diagram for an interior of a vehicle. A vehicle management system can be accomplished based on a text translation layer. The vehicle management system can include analysis of one or more images containing facial data obtained of a vehicle occupant. The facial data can include data such as facial lighting data and facial expression data. The analysis can also be applied to sensor data such as audio data, voice data, physiological data, and so on. The analysis of the images and the data can determine an in-cabin state for the vehicle occupant, and if present, a second vehicle occupant. The in-cabin state can be processed to produce text sentences, where the text sentences describe the state. The text sentences are used to seed a generative AI facility. The generative AI facility produces a response such as a textual response which is used to manage the vehicle. The management of the vehicle can include autonomous and semi-autonomous management of the vehicle. The text produced by the generative AI facility enables a vehicle management system with a text translation layer. One or more images are obtained of a vehicle occupant, using one or more imaging devices within the vehicle, wherein the one or more images include facial data of the vehicle occupant. A computing device is used to analyze the one or more images to determine an in-cabin state. The in-cabin state is processed using a text translation layer, wherein the processing outputs one or more text sentences describing the in-cabin state. A generative artificial intelligence (AI) facility is seeded, using the one or more sentences. The vehicle is managed, based on a textual response from the generative AI facility. In the system diagram 400, one or more occupants of a vehicle 410, such as occupants 420 and 422, can be observed using a microphone 440, one or more cameras 442, 444, or 446, and other audio and image capture techniques. The image data can include video data. The video data and the audio data can include cognitive state data, where the cognitive state data can include facial data, voice data, physiological data, and the like. The occupant can be a driver 420 of the vehicle 410, a passenger 422 within the vehicle, and so on.

The cameras or imaging devices that can be used to obtain images including facial data from the occupants of the vehicle 410 can be positioned to capture the face of the vehicle operator, the face of a vehicle passenger, multiple views of the faces of occupants of the vehicle, and so on. The cameras can be located near a rear-view mirror 414 such as camera 442, positioned near or on a dashboard 416 such as camera 444, positioned within the dashboard such as camera 446, and so on. The microphone 440, or audio capture device, can be positioned within the vehicle such that voice data, speech data, non-speech vocalizations, and so on can be easily collected with minimal background noise. In embodiments, additional cameras, imaging devices, microphones, audio capture devices, and so on can be located throughout the vehicle. In further embodiments, each occupant of the vehicle could have multiple cameras, microphones, etc., positioned to capture video data and audio data from that occupant.

The interior of a vehicle 410 can be a standard vehicle, an autonomous vehicle, a semi-autonomous vehicle, and so on. The vehicle can be a sedan or other automobile, a van, a sport utility vehicle (SUV), a truck, a bus, a special purpose vehicle, and the like. The interior of the vehicle 410 can include standard controls such as a steering wheel 436, a throttle control (not shown), a brake 434, and so on. The interior of the vehicle can include other controls 432 such as controls for seats, mirrors, climate adjustment, audio systems, etc. The controls 432 of the vehicle 410 can be controlled by a controller 430. The controller 430 can control the vehicle 410 in various manners such as autonomously, semi-autonomously, assertively to a vehicle occupant 420 or 422, etc. In embodiments, the controller provides vehicle control or manipulation techniques, assistance, etc. The controller 430 can receive instructions via an antenna 412 or using other wireless techniques. The controller 430 can be preprogrammed to cause the vehicle to follow a specific route. The specific route that the vehicle is programmed to follow can be based on the cognitive state of the vehicle occupant. The specific route can be chosen based on lowest stress, least traffic, most scenic view, shortest route, and so on.

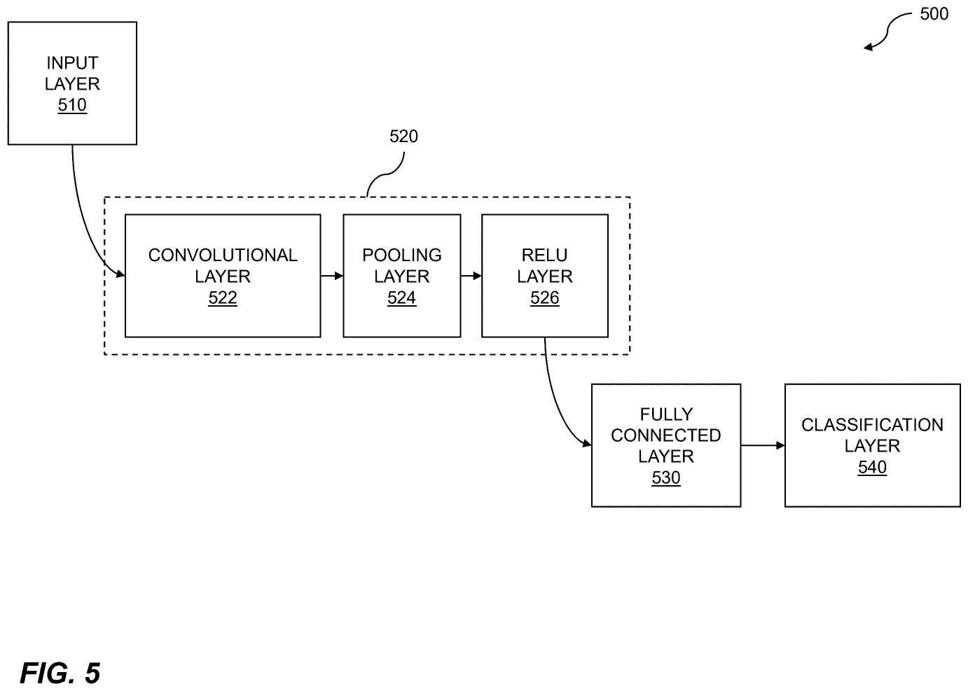

FIG. 5 is an example showing a convolutional neural network (CNN). A convolutional neural network, such as network 500, can be used for a wide variety of applications. The applications for which the CNN can be used can include deep learning, where the deep learning can be applied to various analysis tasks such as facial image analysis. The facial image analysis can be based on facial image attributes. The facial image analysis can be augmented by sensor data analysis, where the sensor data analysis can include audio data, voice data, physiological data, etc. The convolutional neural network can be trained by applying a training dataset, such as a facial image training dataset, to the CNN. The training dataset can be augmented with synthetic data including synthetic images. The trained CNN can enable a vehicular management system with a text translation layer. One or more images are obtained of a vehicle occupant, using one or more imaging devices within the vehicle, wherein the one or more images include facial data of the vehicle occupant. A computing device is used to analyze the one or more images to determine an in-cabin state. The in-cabin state is processed using a text translation layer, wherein the processing outputs one or more text sentences describing the in-cabin state. A generative artificial intelligence (AI) facility is seeded, using the one or more sentences. The vehicle is managed, based on a textual response from the generative AI facility. The CNN can be applied to various tasks such as autonomous vehicle or semiautonomous vehicle management, vehicle content recommendations, and the like. When the imaging and other data collected includes cognitive state data, the cognitive state data can include mental processes, where the mental processes can include attention, creativity, memory, perception, problem solving, thinking, use of language, or the like.

The CNN can be applied to deep learning (DL) applications. Deep learning applications include processing of image data, audio data, and so on. Image data applications include image recognition, facial recognition, etc. Image data applications can include differentiating dogs from cats, identifying different human faces, and the like. The image data applications can include identifying cognitive states, moods, mental states, emotional states, and so on from the facial expressions of the faces that are identified. Audio data applications can include analyzing audio such as ambient room sounds, physiological sounds such as breathing or coughing, noises made by an individual such as tapping and drumming, voices, and so on. The voice data applications can include analyzing a voice for timbre, prosody, vocal register, vocal resonance, pitch, loudness, speech rate, or language content. The voice data analysis can be used to determine one or more cognitive states, moods, mental states, emotional states, etc.

The convolutional neural network is based on layers. The layers can include an input layer, a convolutional layer, a fully connected layer, a classification layer, and so on. The input layer can receive input data such as image data, where the image data can include a variety of formats including pixel formats. The input layer can then perform processing tasks such as identifying boundaries of the face, identifying landmarks of the face, extracting features of the face, and/or rotating a face within the plurality of images. The convolutional layer can represent an artificial neural network such as a convolutional neural network. A convolutional neural network can contain a plurality of hidden layers within it. A convolutional layer can reduce the amount of data feeding into a fully connected layer. The fully connected layer processes each pixel/data point from the convolutional layer. A last layer within the multiple layers can provide output indicative of cognitive state. The last layer of the convolutional neural network can be the final classification layer. The output of the final classification layer can be indicative of the cognitive states of faces within the images that are provided to the input layer. Deep networks such as deep convolutional neural networks can be used for facial expression parsing.

Returning to the figure, FIG. 5 is an example showing a convolutional neural network 500. The convolutional neural network can be used for deep learning, where the deep learning can be applied to image analysis for human perception artificial intelligence. The deep learning system can be accomplished using a variety of networks. In embodiments, the deep learning can be performed using a convolutional neural network. Other types of networks or neural networks can also be used. In other embodiments, the deep learning can be performed using a recurrent neural network. The deep learning can accomplish upper torso identification, facial recognition, analysis tasks, etc. The network includes an input layer 510. The input layer 510 receives image data. The image data can be input in a variety of formats, such as JPEG, TIFF, BMP, and GIF. Compressed image formats can be decompressed into arrays of pixels, wherein each pixel can include an RGB tuple. The input layer 510 can then perform processing such as identifying boundaries of the face, identifying landmarks of the face, extracting features of the face, and/or rotating a face within the plurality of images.

The network includes a collection of intermediate layers 520. The multilayered analysis engine can include a convolutional neural network. Thus, the intermediate layers can include a convolutional layer 522. The convolutional layer 522 can include multiple sublayers, including hidden layers, within it. The output of the convolutional layer 522 feeds into a pooling layer 524. The pooling layer 524 performs a data reduction, which makes the overall computation more efficient. Thus, the pooling layer reduces the spatial size of the image representation to reduce the number of parameters and computation in the network. In some embodiments, the pooling layer is implemented using filters of size 2×2, applied with a stride of two samples for every depth slice along both width and height, resulting in a reduction of 75-percent of the downstream node activations. The multilayered analysis engine can further include a max pooling layer 524. Thus, in embodiments, the pooling layer is a max pooling layer, in which the output of the filters is based on a maximum of the inputs. For example, with a 2×2 filter, the output is based on a maximum value from the four input values. In other embodiments, the pooling layer is an average pooling layer or L2-norm pooling layer. Various other pooling schemes are possible.

The intermediate layers can include a Rectified Linear Units (RELU) layer 526. The output of the pooling layer 524 can be input to the RELU layer 526. In embodiments, the RELU layer implements an activation function such as f(x)−max(0,x), thus providing an activation with a threshold at zero. In some embodiments, the RELU layer 526 is a leaky RELU layer. In this case, instead of the activation function providing zero when x<0, a small negative slope is used, resulting in an activation function such as f(x)=1(x<0)(αx)+1(x>=0)(x). This can reduce the risk of “dying RELU” syndrome, where portions of the network can be “dead” with nodes/neurons that do not activate across the training dataset. The image analysis can comprise training a multilayered analysis engine using the plurality of images, wherein the multilayered analysis engine can include multiple layers that comprise one or more convolutional layers 522 and one or more hidden layers, and wherein the multilayered analysis engine can be used for emotional analysis.

The example 500 includes a fully connected layer 530. The fully connected layer 530 processes each pixel/data point from the output of the collection of intermediate layers 520. The fully connected layer 530 takes all neurons in the previous layer and connects them to every single neuron it has. The output of the fully connected layer 530 provides input to a classification layer 540. The output of the classification layer 540 provides a facial expression and/or cognitive state as its output. Thus, a multilayered analysis engine such as the one depicted in FIG. 5 processes image data using weights, models the way the human visual cortex performs object recognition and learning, and effectively analyzes image data to infer facial expressions and cognitive states.

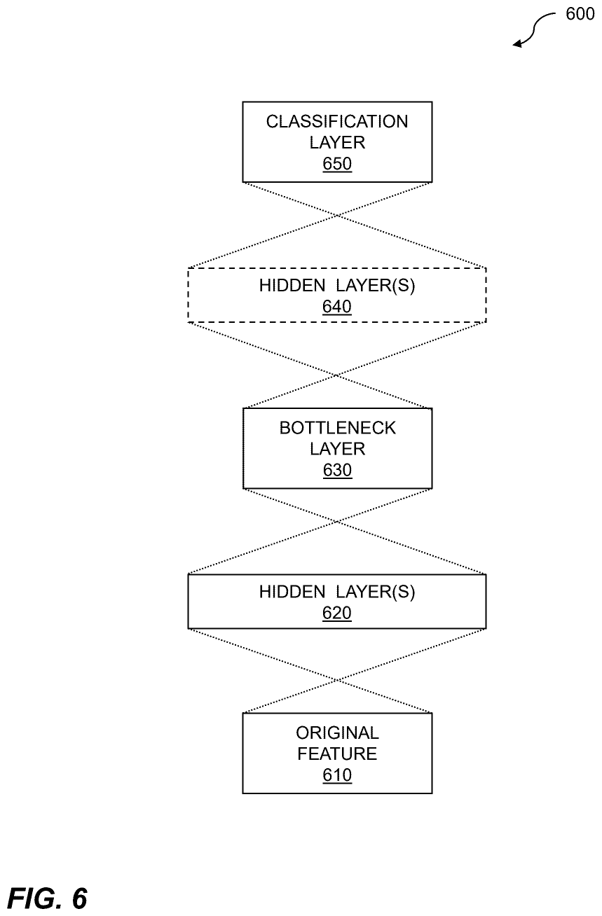

FIG. 6 illustrates a bottleneck layer within a deep learning environment. The deep learning environment can include a machine learning system, where the machine learning system can be based on a neural network such as a deep neural network. The deep neural network comprises a plurality of layers such as input layers, output layers, convolutional layers, residual block layers, pixel shuffling layers, activation layers, and so on. The plurality of layers in a deep neural network (DNN) can include a bottleneck layer. The bottleneck layer can be used for neural network training, where the training can be applied to a vehicular management system with text translation layer. The neural network that is trained can be applied to analysis such as image analysis of facial images for facial elements, audio analysis, physiological analysis, etc. A deep neural network can apply classifiers such as object classifiers, image classifiers, facial classifiers, facial expression classifiers, audio classifiers, speech classifiers, physiological classifiers, and so on. The classifiers can be learned by analyzing one or more of facial elements, cognitive states, cognitive load metrics, interaction metrics, etc. One or more images are obtained of a vehicle occupant, using one or more imaging devices within the vehicle, wherein the one or more images include facial data of the vehicle occupant. A computing device is used to analyze the one or more images to determine an in-cabin state. The in-cabin state is processed using a text translation layer, wherein the processing outputs one or more text sentences describing the in-cabin state. A generative artificial intelligence (AI) facility is seeded, using the one or more sentences. The vehicle is managed, based on a textual response from the generative AI facility.

Layers of a deep neural network can include a bottleneck layer. A bottleneck layer can be used for a variety of applications such as identification of a facial portion, identification of an upper torso, facial recognition, voice recognition, emotional state recognition, and so on. In the illustration 600, a deep neural network in which a bottleneck layer is located can include a plurality of layers. The plurality of layers can include an original feature layer 610. A feature such as an image feature can include points, edges, objects, boundaries between and among regions, properties, and so on. The deep neural network can include one or more hidden layers 620. The one or more hidden layers can include nodes, where the nodes can include nonlinear activation functions and other techniques. The bottleneck layer can be a layer that learns translation vectors to transform a neutral face to an emotional or expressive face. In some embodiments, the translation vectors can transform a neutral sounding voice to an emotional or expressive voice. Specifically, activations of the bottleneck layer determine how the transformation occurs. A single bottleneck layer can be trained to transform a neutral face or voice to a different emotional face or voice. In some cases, an individual bottleneck layer can be trained for a transformation pair. At runtime, once the user's emotion has been identified and an appropriate response to it can be determined (mirrored or complementary), the trained bottleneck layer can be used to perform the needed transformation.

The deep neural network can include a bottleneck layer 630. The bottleneck layer can include a fewer number of nodes than the one or more preceding hidden layers. The bottleneck layer can create a constriction in the deep neural network or other network. The bottleneck layer can force information that is pertinent to a classification, for example, into a low dimensional representation. The bottleneck features can be extracted using an unsupervised technique. In other embodiments, the bottleneck features can be extracted using a supervised technique. The supervised technique can include training the deep neural network with a known dataset. The features can be extracted from an autoencoder such as a variational autoencoder, a generative autoencoder, and so on. The deep neural network can include hidden layers 640. The number of the hidden layers can include zero hidden layers, one hidden layer, a plurality of hidden layers, and so on. The hidden layers following the bottleneck layer can include more nodes than the bottleneck layer. The deep neural network can include a classification layer 650. The classification layer can be used to identify the points, edges, objects, boundaries, and so on, described above. The classification layer can be used to identify cognitive states, mental states, emotional states, moods, and the like. The output of the final classification layer can be indicative of the emotional states of faces within the images, where the images can be processed using the deep neural network.

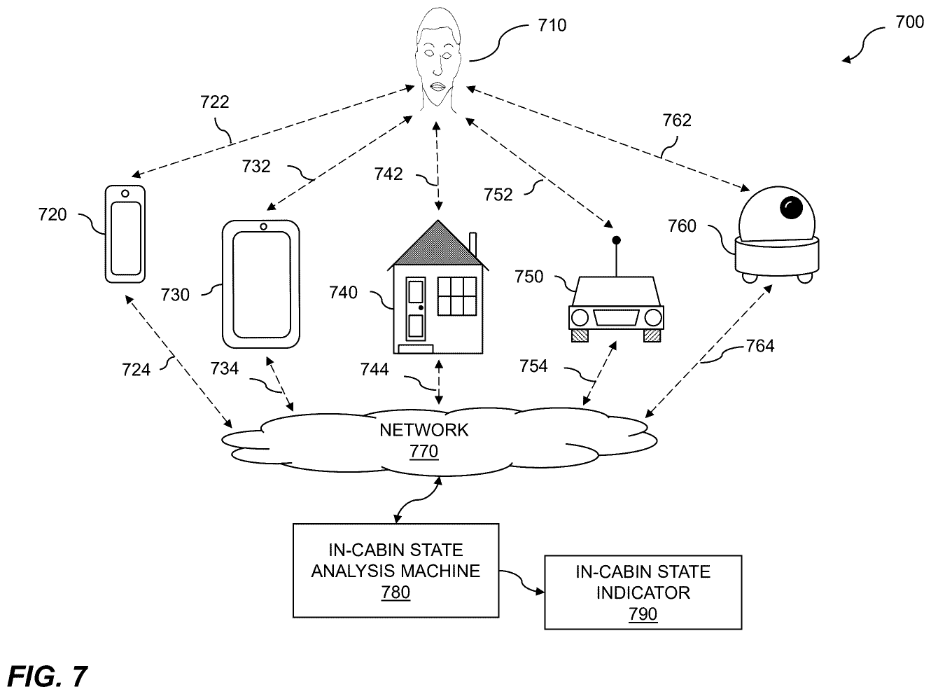

FIG. 7 illustrates data collection including devices and locations. Data, including imaging data, facial image data, torso data, video data, audio data, and physiological data, can be obtained for machine learning. The machine learning can be applied to management systems such as a vehicular management system with text translation layer. The training, imaging, audio, physiological, and other data can be obtained from multiple devices, vehicles, and locations. One or more images are obtained of a vehicle occupant using one or more imaging devices within the vehicle, wherein the one or more images include facial data of the vehicle occupant. A computing device is used to analyze the one or more images to determine an in-cabin state. The in-cabin state is processed using a text translation layer, wherein the processing outputs one or more text sentences describing the in-cabin state. A generative artificial intelligence (AI) facility is seeded using the one or more sentences. The vehicle is managed based on a textual response from the generative AI facility.

In the illustration 700, multiple mobile devices, vehicles, and locations can be used separately or in combination to collect imaging, video data, audio data, physiological data, training data, etc., on a user. The imaging can include video data, where the video data can include upper torso data. Other data, such as audio data, physiological data, and so on, can be collected on the user. While one person (user) is shown, the video data or other data can be collected on multiple people (users). A user 710 can be observed as she or he is performing a task, experiencing an event, viewing a media presentation, and so on. The user 710 can be shown one or more media presentations, political presentations, social media events, or another form of displayed media. The one or more media presentations can be shown to a plurality of people. The media presentations can be displayed on an electronic display coupled to a client device. The data collected on the user 710 or on a plurality of users can be in the form of one or more videos, video frames, still images, etc. The plurality of videos can be of people who are experiencing different situations. Some example situations can include the user or plurality of users being exposed to TV programs, movies, video clips, social media, social sharing, and other such media. The situations could also include exposure to media such as advertisements, political messages, news programs, and so on. As previously noted, video data can be collected on one or more users in substantially identical or different situations, and viewing either a single media presentation or a plurality of presentations. The data collected on the user 710 can be analyzed and viewed for a variety of purposes including body position or body language analysis, expression analysis, mental state analysis, cognitive state analysis, and so on. The electronic display can be on a smartphone 720 as shown, a tablet computer 730, a personal digital assistant, a television, a mobile monitor, or any other type of electronic device. In one embodiment, expression data is collected on a mobile device such as a cell phone 720, a tablet computer 730, a laptop computer, or a watch. Thus, the multiple sources can include at least one mobile device, such as a phone 720 or a tablet 730, or a wearable device such as a watch or glasses (not shown). A mobile device can include a front-side camera and/or a back-side camera that can be used to collect expression data. Sources of expression data can include a webcam, a phone camera, a tablet camera, a wearable camera, and a mobile camera. A wearable camera can comprise various camera devices, such as a watch camera. In addition to using client devices for data collection from the user 710, data can be collected in a house 740 using a web camera or the like; in a vehicle 750 using a web camera, client device, etc.; by a social robot 760; and so on.

As the user 710 is monitored, the user 710 might move due to the nature of the task, boredom, discomfort, distractions, or for another reason. As the user moves, the camera with a view of the user's face can be changed. Thus, as an example, if the user 710 is looking in a first direction, the line of sight 722 from the smartphone 720 is able to observe the user's face, but if the user is looking in a second direction, the line of sight 732 from the tablet 730 is able to observe the user's face. Furthermore, in other embodiments, if the user is looking in a third direction, the line of sight 742 from a camera in the house 740 is able to observe the user's face, and if the user is looking in a fourth direction, the line of sight 752 from the camera in the vehicle 750 is able to observe the user's face. If the user is looking in a fifth direction, the line of sight 762 from the social robot 760 is able to observe the user's face. If the user is looking in a sixth direction, a line of sight from a wearable watch-type device, with a camera included on the device, is able to observe the user's face. In other embodiments, the wearable device is another device, such as an earpiece with a camera, a helmet or hat with a camera, a clip-on camera attached to clothing, or any other type of wearable device with a camera or other sensor for collecting expression data. The user 710 can also use a wearable device including a camera for gathering contextual information and/or collecting expression data on other users. Because the user 710 can move her or his head, the facial data can be collected intermittently when she or he is looking in a direction of a camera. In some cases, multiple people can be included in the view from one or more cameras, and some embodiments include filtering out faces of one or more other people to determine whether the user 710 is looking toward a camera. All or some of the expression data can be continuously or sporadically available from the various devices and other devices.

The captured video data can include cognitive content, such as facial expressions, etc., and can be transferred over a network 770. The network can include the Internet or another computer network. The smartphone 720 can share video using a link 724, the tablet 730 using a link 734, the house 740 using a link 744, the vehicle 750 using a link 754, and the social robot 760 using a link 764. The links 724, 734, 744, 754, and 764 can be wired, wireless, and hybrid links.

The captured video data, including facial expressions, can be analyzed on an in-cabin analysis machine 780. The facial expressions can also be analyzed on a computing device such as the video capture device, or on another separate device. The analysis could take place on one of the mobile devices discussed above, on a local server, on a remote server, on a cloud server, and so on. In embodiments, some of the analysis takes place on the mobile device, while other analysis takes place on a server device. The analysis of the video data can include the use of a classifier. The video data can be captured using one of the mobile devices discussed above and sent to a server or another computing device for analysis. However, the captured video data including expressions can also be analyzed on the device which performed the capturing. The analysis can be performed on a mobile device where the videos were obtained with the mobile device and wherein the mobile device includes one or more of a laptop computer, a tablet, a PDA, a smartphone, a wearable device, and so on. In another embodiment, the analyzing comprises using a classifier on a server or another computing device different from the capture device. The analysis data from the in-cabin analysis machine can be processed by an in-cabin state indicator 790. The in-cabin state indicator 790 can indicate cognitive states, mental states, moods, emotions, etc. In embodiments, the cognitive state can include drowsiness, fatigue, distraction, impairment, sadness, stress, happiness, anger, frustration, confusion, disappointment, hesitation, cognitive overload, focusing, engagement, attention, boredom, exploration, confidence, trust, delight, disgust, skepticism, doubt, satisfaction, excitement, laughter, calmness, curiosity, humor, depression, envy, sympathy, embarrassment, poignancy, or mirth.

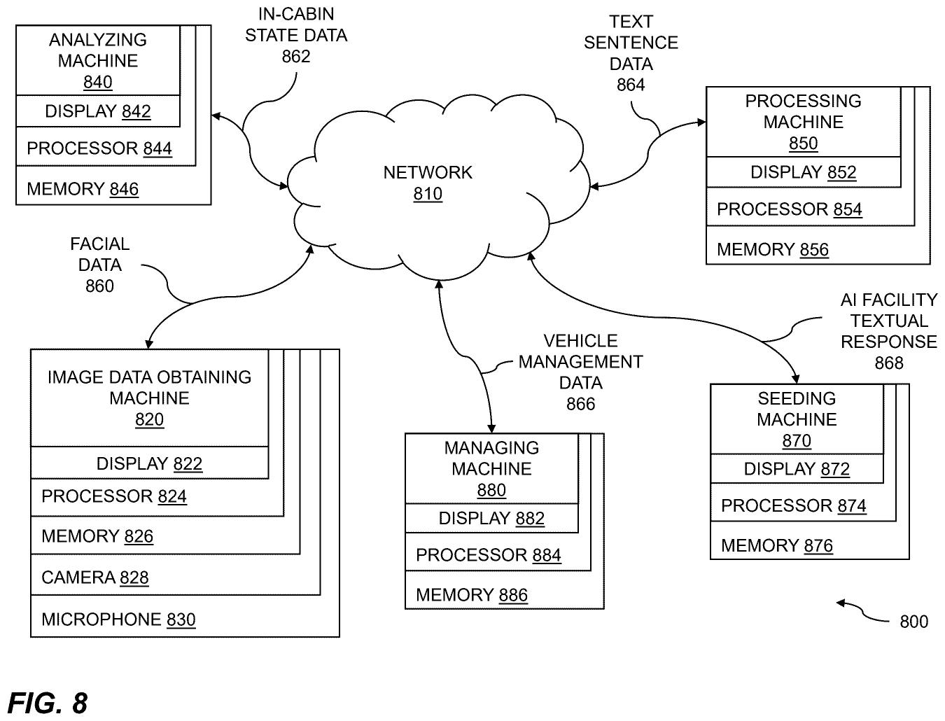

FIG. 8 is a system for a vehicle management system with a text translation layer. The vehicle management can be accomplished using one or more computers or processors on which one or more artificial intelligence (AI) applications are executed. An Al application can include a generative Al facility. The Al facility can generate a textual response to an in-cabin state. An example system 800 which can perform vehicular management is shown. The system 800 can include a memory which stores instructions and one or more processors coupled to the memory, wherein the one or more processors, when executing the instructions which are stored, are configured to: obtain one or more images of a vehicle occupant, using one or more imaging devices within the vehicle, wherein the one or more images include facial data of the vehicle occupant; analyze, using a computing device, the one or more images to determine an in-cabin state; process the in-cabin state using a text translation layer, wherein the processing outputs one or more text sentences describing the in-cabin state; seed a generative artificial intelligence (AI) facility, using the one or more sentences; and manage the vehicle, based on a textual response from the generative AI facility.

In embodiments, the text translation layer can enable integration with diverse generative AI facilities. The diverse generative AI facilities can include ChatGPT™, Scribe™, Jasper™, Generative Design™, Dall-E2, Notion™, Wordtune™, Github Copilot™, Speechify™, VEED™, and so on. The text translation layer can be configurable. In embodiments, the text translation layer is configurable using configurability parameters. A variety of configuration parameters can be used. In embodiments, the configuration parameters can include in-cabin signal selection, verbosity settings for text sentences, text sentence consolidation prior to seeding the generative AI facility, and the like. In addition to the one or more imaging devices, in-cabin sensors can be located within the vehicle. The in-cabin sensors can include one or more audio sensors to detect one or more of a voice; human-generated sounds such as sighs, yawns, snoring; and so on. The one or more audio sensors can detect speech such as a conversation between a vehicle operator and a passenger, singing, an argument with an audio stream, etc. The in-cabin sensors can further include an ambient light sensor, a temperature sensor, etc. Embodiments can further include augmenting the one or more images with in-cabin sensor data. The augmenting sensor data and image data can aid the determining of in-cabin states such as a driver yawning with a warm cabin temperature, heavy traffic with driver irritation, and so on.

The system 800 can include one or more image data obtaining machines 820 linked to a first analyzing machine 840, a processing machine 850, a seeding machine 870, and a managing machine 880 via a network 810 or another computer network. The images can include video data, frame images, multi-camera images, etc. The images can include facial data of one or more occupants of a vehicle. The network can be wired or wireless, a computer network such as the Internet, a local area network (LAN), a wide area network (WAN), and so on. Facial data 860 such as facial image data, facial element data, training data, and so on can be transferred to the analyzing machine 840 through the network 810. The example image data obtaining machine 820 comprises one or more processors 824 coupled to a memory 826 which can store and retrieve instructions, a display 822, a camera 828, and a microphone 830. The camera 828 can include a webcam, a video camera, a still camera, a thermal imager, a CCD device, a phone camera, a three-dimensional camera, a depth camera, a light field camera, multiple webcams used to show different views of a person, or any other type of image capture technique that can allow captured data to be used in an electronic system. The microphone can include any audio capture device that can enable captured audio data to be used by the electronic system. The memory 826 can be used for storing instructions, video data including facial images, facial expression data, facial lighting data, etc. on a plurality of people; audio data from the plurality of people; one or more classifiers; and so on. The display 822 can be any electronic display, including but not limited to, a computer display, a laptop screen, a netbook screen, a tablet computer screen, a smartphone display, a mobile device display, a remote with a display, a television, a projector, or the like.

The analyzing machine 840 can include one or more computing devices, one or more processors 844, etc. coupled to a memory 846 which can store and retrieve instructions, and can also include a display 842. The analyzing machine 840 can receive the facial image data 860 and can analyze the facial image to determine an in-cabin state 862. In embodiments, the in-cabin state can include a driver state and one or more passenger states. The driver state and the one or more passenger states can include mental states, cognitive states, moods, and so on. In embodiments, the driver state and the one or more passenger states can include corresponding occupant-present signals. The occupant-present signal can include an occupant in the front passenger seat, a passenger in the rear of the vehicle, etc. In embodiments, the occupant-present signals can condition the processing. In a usage example, a passenger is present in the front passenger seat. The processing can include determining suggestions such as switching drivers, engaging with the driver, avoiding distracting the driver, and the like. In other embodiments, the driver state and the one or more passenger states can include emotional state, gaze direction, and/or verbal participation.

The facial image data can include facial image data associated with a vehicle driver or operator, facial image data associated with one or more passengers if present, and so on. In embodiments, the facial image data can describe a characteristic or feature associated with the face within the image that can be identified within the image. A facial characteristic or feature can be associated with an attribute subspace, where the attribute subspace can include facial image lighting, a facial image expression, and so on. Facial image lighting can include a direction from which the light emanates. A facial image expression can include a smile, frown, smirk, grimace, neutral expression, etc. The in-cabin state can include one or more parameters associated with the driver, a passenger, if present, and so on. In embodiments, the in-cabin state can include driver seat occupied, passenger seat occupied, driver seatbelt status, passenger seatbelt status, and so on.

The analyzing machine outputs the in-cabin state data 862 for processing by the processing machine 850. The processing machine can include one or more processors 854 coupled to a memory 856 which can store and retrieve instructions, and can also include a display 852. The processing machine 850 can receive the in-cabin state data 862 and can process the in-cabin state data using a text translation layer. In embodiments, the in-cabin state can include one or more true/false statements, yes/no statements, etc. The processing outputs one or more text sentences describing the in-cabin state. The text translation layer can translate a parameter associated with an in-cabin state into a text sentence. In a usage example, the in-cabin state parameter “driver_seat_belt_status” can be false. The text translation layer can translate the false parameter value into a sentence such as, “The driver is not using their seatbelt.” The text translation layer can be configured. Further embodiments can include configuring the text translation layer using configurability parameters. The configurability parameters can be used to select a text language, an amount of text, a complexity of text, and so on. In embodiments, the configurability parameters can include a verbosity setting for the one or more text sentences. The verbosity setting can be used to set a maximum number of words, a complexity of text vocabulary, etc. In other embodiments, the configurability parameters can enable consolidating the one or more text sentences. The consolidating can include appending a sentence to another sentence, combing the sentences with an “and” or an “or”, and so on. The consolidating the sentences can be accomplished prior to seeding a generative artificial intelligence (AI) facility (discussed below). In other embodiments, the in-cabin state can include output from a software development kit (SDK) that includes the text translation layer. The SDK can be provided by a generative AI facility vendor, uploaded by a user, downloaded from a repository of SDKs, etc. The processing machine can send the generated text sentence data 864 to the seeding machine 870.

The seeding machine 870 can include one or more processors 874 coupled to a memory 876, which can store and retrieve instructions, and can also include a display 872. The seeding machine 870 can receive the text sentence data 864 and can seed a generative artificial intelligence (AI) facility. Mentioned previously and throughout, the generative AI facility can include ChatGPT™, Scribe™, Jasper™, Generative Design™, Dall-E2, Notion™, Wordtune™ Github Copilot™, Speechify™, VEED™, etc. The generative AI facility can generate a textual response 868. The textual response can include a recommendation such as a recommendation to the vehicle operator or the vehicle passenger, a vehicle management instruction to a vehicle such as an autonomous or semiautonomous vehicle, and the like. In embodiments, the text translation layer previously discussed can provide a prompt to the generative AI facility to enable the seeding. The prompt can include the one or more sentences, parameters, an emphasis level, etc. The emphasis level can include a calm level, a conversational level, a friendly level, an urgent level, and so on. In a usage example, the sentences, parameters, emphasis level, etc. used to seed the AI can include, “Driver not wearing seatbelt. Driver appears tired. Verbosity parameter is moderate.” Further instructions and directives can be used to seed the AI facility. In embodiments, the prompt can include metadata instructions to the generative AI facility. The metadata can include a vehicle management language; a voice selection such as a female, male, soothing, or authoritative voice; a speed and prosody of the voice; and so on. The textual response 868 from the seeding machine can be sent to the managing machine 880.

The managing machine 880 can include one or more processors 884 coupled to a memory 886 which can store and retrieve instructions, and can also include a display 882. The managing machine 880 can receive the AI facility textual response data 868 and can manage the vehicle 866. The managing the vehicle can include making suggestions and providing information to the operator of the vehicle; making suggestions and providing information to the passenger if present; and so on. The managing the vehicle can include converting operation of the vehicle from operator control to autonomous or semiautonomous control. The managing the vehicle can include a message, a display rendered on a dashboard within the vehicle, etc. In embodiments, the managing the vehicle can be enabled by a voice agent vocalizing the textual response from the generative AI facility. In a usage example, analysis of the images obtained of the vehicle occupant indicates that the driver is not wearing a seatbelt. The generative AI facility can return a voice message such as, “Driver, please click your seatbelt for safety.” In another usage example, analysis of the obtained images identifies that the driver is drowsy. The vehicle management can include recommending cracking the window to obtain some reviving fresh air, adjusting the cabin temperature, stopping for a rest, switching drivers with a passenger, etc. Further embodiments can include seeding an additional generative AI facility response, based on a change of the in-cabin state subsequent to the managing. In a usage example, the driver ignores the vehicle management recommendation. An additional AI facility response can be sought to try to find a message to which the driver is more likely to respond. The additional response can include an urgent message, transferring control of the vehicle from manual to autonomous, etc.

In embodiments, the managing the vehicle can include providing vehicle manipulation instructions. Discussed throughout, the providing the vehicle management instructions can include text, automatic changes, changes to vehicle control, and so on. In embodiments, the vehicle manipulation instructions can be delivered audibly within the vehicle. The audio instruction can be delivered through a sound system within the vehicle, via an “always on” audio system such as an alert system, and so on. The audibly delivered vehicle manipulation instructions can be delivered to one or more people within the vehicle. In embodiments, the vehicle manipulation instructions that are delivered audibly can be directed to a driver of the vehicle. The instructions can include safety instructions, recommendations for an alternate travel route, playing a soundtrack, adjustment of lighting, etc. In embodiments, the vehicle manipulation instructions can modify vehicle in-cabin climate settings. In other embodiments, the vehicle manipulation instructions that are delivered audibly can be directed to a passenger of the vehicle. The instructions can include adjustments for passenger comfort, travel information, suggestions to engage with the driver to help keep the driver awake, etc. In further embodiments, the vehicle manipulation instructions can modify vehicle control. The vehicle control can include manual control, autonomous control, and semiautonomous control. The vehicle that is being controlled can include a vehicle associated with a fleet of vehicles. In embodiments, the vehicle manipulation instructions can enable fleet monitoring. The fleet monitoring can include controlling access to a vehicle, monitoring vehicle operation such as safe operation, tracking a fleet vehicle, and the like.

In embodiments, the vehicle manipulation instructions can trigger a continued dialogue between the text translation layer and the generative AI facility. The continued dialogue can result from changing travel conditions such as road conditions due to weather conditions, construction, or an accident; increasing levels of traffic; indication of driver inattention or impairment; etc. The continued dialogue can result from changing observed conditions within the vehicle. In embodiments, the continued dialogue can enable increasing or decreasing severity of additional vehicle management actions. In a usage example, a driver is determined to be drowsy. A vehicle management instruction can include switching drivers, pulling over for a rest, cracking a window for fresh air, etc. If the drowsiness of the driver progresses to sleep, then the management instructions can become louder, more forceful, more urgent, etc.

The system 800 can include a computer program product embodied in a non-transitory computer readable medium for vehicular management, the computer program product comprising code which causes one or more processors to perform operations of: obtaining one or more images of a vehicle occupant, using one or more imaging devices within the vehicle, wherein the one or more images include facial data of the vehicle occupant; analyzing, using a computing device, the one or more images to determine an in-cabin state; processing the in-cabin state using a text translation layer, wherein the processing outputs one or more text sentences describing the in-cabin state; seeding a generative artificial intelligence (AI) facility, using the one or more sentences; and managing the vehicle, based on a textual response from the generative AI facility.

The system 800 can include a computer program product embodied in a non-transitory computer readable medium for vehicular management, the computer program product comprising code which causes one or more processors to generate semiconductor logic for: obtaining one or more images of a vehicle occupant, using one or more imaging devices within the vehicle, wherein the one or more images include facial data of the vehicle occupant; analyzing, using a computing device, the one or more images to determine an in-cabin state; processing the in-cabin state using a text translation layer, wherein the processing outputs one or more text sentences describing the in-cabin state; seeding a generative artificial intelligence (AI) facility, using the one or more sentences; and managing the vehicle, based on a textual response from the generative AI facility.

Each of the above methods may be executed on one or more processors on one or more computer systems. Each of the above methods may be implemented on a semiconductor chip and programmed using special purpose logic, programmable logic, and so on. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for vehicular management comprising:
obtaining one or more images of a vehicle occupant, using one or more imaging devices within the vehicle, wherein the one or more images include facial data of the vehicle occupant;
analyzing, using a computing device, the one or more images to determine an in-cabin state;
processing the in-cabin state using a text translation layer, wherein the processing outputs one or more text sentences describing the in-cabin state;
seeding a generative artificial intelligence (AI) facility, using the one or more sentences; and
managing the vehicle, based on a textual response from the generative AI facility.

2. The method of claim 1 wherein the text translation layer enables integration with diverse generative AI facilities.

3. The method of claim 1 further comprising configuring the text translation layer using configurability parameters.

4. The method of claim 3 wherein the configurability parameters include in-cabin state signal selection.

5. The method of claim 3 wherein the configurability parameters include a verbosity setting for the one or more text sentences.

6. The method of claim 3 wherein the configurability parameters enable consolidating the one or more text sentences prior to the seeding.

7. The method of claim 1 wherein the text translation layer provides a prompt to the generative AI facility to enable the seeding.

8. The method of claim 7 wherein the prompt includes metadata instructions to the generative AI facility.

9. The method of claim 8 wherein the metadata instructions include voice characteristics.

10. The method of claim 1 wherein the managing the vehicle comprises captioning key moments within the vehicle.

11. The method of claim 10 wherein the key moments include in-cabin state changes.

12. The method of claim 1 wherein the managing the vehicle comprises indexing in-cabin state information.

13. The method of claim 12 wherein the indexing enables data mining of an in-cabin state timeline.

14. The method of claim 12 wherein the indexing enables synchronization of in-cabin state changes and one or more responses from the generative AI facility.

15. The method of claim 1 wherein the managing the vehicle is enabled by a voice agent vocalizing the textual response from the generative AI facility.

16. The method of claim 15 further comprising seeding an additional generative AI facility response, based on a change of the in-cabin state subsequent to the managing.

17. The method of claim 1 wherein the managing the vehicle comprises providing vehicle manipulation instructions.

18. The method of claim 17 wherein the vehicle manipulation instructions are delivered audibly within the vehicle.

19. The method of claim 18 wherein the vehicle manipulation instructions that are delivered audibly are directed to a driver of the vehicle.

20. The method of claim 18 wherein the vehicle manipulation instructions that are delivered audibly are directed to a passenger of the vehicle.

21. The method of claim 17 wherein the vehicle manipulation instructions are delivered electronically to an autonomous or semi-autonomous vehicle control processor.

22. The method of claim 17 wherein the vehicle manipulation instructions trigger a continued dialogue between the text translation layer and the generative AI facility.

23. The method of claim 22 wherein the continued dialogue enables increasing or decreasing severity of additional vehicle management actions.

24. A computer program product embodied in a non-transitory computer readable medium for vehicular management, the computer program product comprising code which causes one or more processors to perform operations of:
obtaining one or more images of a vehicle occupant, using one or more imaging devices within the vehicle, wherein the one or more images include facial data of the vehicle occupant;
analyzing, using a computing device, the one or more images to determine an in-cabin state;
processing the in-cabin state using a text translation layer, wherein the processing outputs one or more text sentences describing the in-cabin state;
seeding a generative artificial intelligence (AI) facility, using the one or more sentences; and
managing the vehicle, based on a textual response from the generative AI facility.

25. A computer system for vehicular management comprising:
a memory which stores instructions;
one or more processors coupled to the memory wherein the one or more processors, when executing the instructions which are stored, are configured to:
obtain one or more images of a vehicle occupant, using one or more imaging devices within the vehicle, wherein the one or more images include facial data of the vehicle occupant;
analyze, using a computing device, the one or more images to determine an in-cabin state;
process the in-cabin state using a text translation layer, wherein the processing outputs one or more text sentences describing the in-cabin state;
seed a generative artificial intelligence (AI) facility, using the one or more sentences; and
manage the vehicle, based on a textual response from the generative AI facility.
